(19) United States
(12) Patent Application Publication
(10) Pub. No.: US 2009/0322846 A1
(43) Pub. Date: Dec. 31, 2009

(54) OPTICAL SCANNING APPARATUS AND IMAGE FORMING APPARATUS

(76) Inventor: Hideki Kashimura, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 12/401,970

(22) Filed: Mar. 11, 2009

(30) Foreign Application Priority Data
Jun. 25, 2008 (JP) P2008-166513

(51) Int. Cl. B41J 2/385; G02B 26/10

(52) U.S. Cl. 347/129; 359/204.1

(57) ABSTRACT

An optical scanning apparatus includes: a light source that emits multiple light beams; a deflecting unit that accepts the multiple light beams emitted from the light source on an identical reflecting surface of the deflecting unit, and movies the reflecting surface to deflect the multiple light beams; and an optical system that is interposed between the reflecting surface of the deflecting unit and a surface to be scanned and converges the multiple light beams reflected by the reflecting surface respectively. And the optical system includes an optical element that converges lights at least in a sub scanning direction. The optical scanning apparatus includes an adjust unit that adjusts incident angles of the multiple light beams radiated onto the optical element, in a direction corresponding to the sub scanning direction on the surface to be scanned.

### CROSS-REFERENCE TO RELATED APPLICATIONS

This application is based on and claims priority under 35 USC 119 from Japanese Patent Application No. 2008-166513 filed Jun. 25, 2008.

### BACKGROUND

1. Technical Field

The present invention relates to an optical scanning apparatus and an image forming apparatus which are structured such that they receive multiple light beams emitted from a light source on an identical reflecting surface of a deflecting unit, deflect the multiple light beams, and Scan a surface to be scanned simultaneously using the deflected multiple light beams.

2. Related Art

As a laser printer, an electro-photographic copying machine and the like, there has been popularized an image forming apparatus which radiates blinking light beams onto an image carrier having a sensitive layer according to image data to thereby form latent images based on differences between electrostatic potentials. In this type of image forming apparatus, the endless shaped peripheral surfaces of a peripherally revolving image carrier are scanned by light beams in the width direction of the endless shaped peripheral surface and also the endless shaped peripheral surface is moved in the peripheral direction thereof to be scanned by the light beams in a sub scanning direction, thereby forming the latent images on the sensitive layer of the image carrier.

In the above-mentioned optical scanning apparatus, generally, light beams output from a semiconductor laser are modulated according to image data and the modulated light beams are radiated onto the reflecting surface of a rotational polygonal mirror rotating at a given speed through a collimater lens or the like. Due to the rotation of the rotational polygonal mirror, the deflect angles of the light beams are varied successively. The deflected light beams are guided through f θ lenses, a cylinder mirror or a cylinder lens, and the like to the endless shaped peripheral surface of an image carrier, thereby scanning such peripheral surface at a constant speed and forming images on the peripheral surface of the image carrier.

Such optical scanning apparatus is requested to be able to enhance the scanning speed in order to increase the forming speed of the images. As a technology for enhancing the speed of the light beam scanning operation, there is proposed an optical scanning apparatus employing a simultaneous scanning method which can scan multiple scanning lines simultaneously in one scanning operation using multiple light beams. In this optical scanning apparatus, a light source has multiple light emitting points and it emits multiple light beams in such a manner that they are parallel to each other. And, these light beams are deflected on the identical reflecting surface of the identical deflecting unit, and the peripheral surface of an image carrier is scanned by the multiple light beams simultaneously in the main scanning direction.

The optical scanning apparatus for scanning the scanning lines simultaneously using the multiple light beams is required to reduce so called “Defferential bow” and “beam pitch error” generated between the multiple light beams. FIG. 16 shows the Defferential bow generated when four light beams are scanned simultaneously, while FIG. 17 shows the beam pitch error generated when four light beams are scanned simultaneously. In the respective figures, a broken line represents an ideal scanning line, while a solid line represents a scanning line in which the “Defferential bow” or “beam pitch error” is generated.

The above-mentioned “Defferential bow” indicates that the curve amounts of scanning lines formed by the respective light beams differ from each other and, depending on scanning positions in the main scanning direction, a space between the two light beams in the sub-scanning direction is varied.

The “Defferential bow” is caused mainly by the following two factors. One is that the light beams are radiated onto the rotational polygonal mirror with an angle in the sub scanning direction. The other is that, when the light beams pass through the f θ lens having a power in the sub scanning direction, they pass outside the optical axis of the f θ lens or the light beams are radiated onto the f θ lens with an angle in the sub scanning direction.

Also, the “beam pitch error” indicates that the scanning lines are scanned in a state where a space between the light beams in the sub scanning direction is shifted from a given value, whereby the space between the scanning lines becomes rough. When multiple scanning lines are scanned simultaneously in one scanning operation using multiple light beams, if such “Defferential bow” or “beam pitch error” is generated, there is caused unevenness in an image in the sub scanning direction to thereby deteriorate the quality of the image.

### SUMMARY

According to an aspect of the invention, an optical scanning apparatus includes: a light source that emits multiple light beams; a deflecting unit that accepts the multiple light beams emitted from the light source on an identical reflecting surface of the deflecting unit, and movies the reflecting surface to deflect the multiple light beams; and an optical system that is interposed between the reflecting surface of the deflecting unit and a surface to be scanned and converges the multiple light beams reflected by the reflecting surface respectively. The surface to be scanned is scanned using the deflected multiple light beams in a main scanning direction. And the multiple light beams are used to scan positions different from each other in a sub scanning direction crossing with the main scanning direction. And the optical system includes a optical element that converges lights at least in the sub scanning direction. The optical scanning apparatus further includes an adjust unit that adjusts incident angles of the multiple light beams radiated onto the optical element, in a direction corresponding to the sub scanning direction on the surface to be scanned.

### BRIEF DESCRIPTION OF THE DRAWINGS

Exemplary embodiment(s) of the present invention will be described in detail based on the following figures, wherein:

FIG. 1 is a schematic structure view of an image forming apparatus according to a first exemplary embodiment of the invention;

FIG. 2 is a schematic structure view of an optical scanning apparatus according to a first exemplary embodiment of the invention, for use in the image forming apparatus shown in FIG. 1;

FIG. 3 is a schematic view of the optical structure of the optical scanning apparatus shown in FIG. 2;

FIGS. 4A and 4B are schematic views of a light beam emitting surface of a laser device used in the optical scanning apparatus shown in FIGS. 2 and 3;

FIG. 5 is a schematic optical path view to explain a scanning space between multiple light beams in the optical scanning apparatus shown in FIGS. 2 and 3;

FIG. 6 is a schematic optical path view to explain the scanning space between multiple light beams in the optical scanning apparatus shown in FIGS. 2 and 3;

FIG. 7 is a schematic optical path view to explain the scanning space between multiple light beams in the optical scanning apparatus shown in FIGS. 2 and 3;

FIG. 8 is a graphical representation of the results obtained from a test conducted in order to confirm the effects of the invention; and, specifically, it shows the results obtained from the test in which, when two light beams are scanned on a sensitive drum, the scanning space in a sub scanning direction is measured at the respective points in a main scanning direction when the scanning space in the sub scanning direction is adjusted;

FIG. 9 is a graphical representation of the results obtained from a test conducted in order to confirm the effects of the invention; and, specifically it shows the results obtained from the test in which, when two light beams are scanned on a sensitive drum, the amount of shift in the focal position in a sub-scanning direction is measured at the respective points in a main scanning direction when the scanning space in the sub-scanning direction is adjusted;

FIG. 10 is a graphical representation of the results obtained from a test conducted in order to confirm the effects of the invention; and, specifically it shows the results obtained from the test in which, when two light beams are scanned on a sensitive drum, the amount of variation in the incident angles of the two light beams to be radiated onto a surface to be scanned is measured at the respective points in a main scanning direction when the scanning space in the sub-scanning direction is adjusted;

FIG. 11 is a schematic structure view of an optical scanning apparatus according to a second exemplary embodiment of the invention;

FIG. 12 is a schematic view of the optical structure of the optical scanning apparatus shown in FIG. 11;

FIGS. 13A and 13B are schematic optical path views to explain a structure which is used to adjust the scanning space between multiple light beams in the optical scanning apparatus shown in FIGS. 11 and 12;

FIG. 14 is a schematic view of the optical structure of an optical scanning apparatus according to a third exemplary embodiment of the invention;

FIG. 15 is a schematic view to explain a method for adjusting the scanning space between multiple light beams in the sub scanning direction using scanning lines on the surface to be scanned;

FIG. 16 is a schematic view to explain a so called “Defferential bow” which can be generated in an optical scanning apparatus for scanning by multiple light beams simultaneously; and

FIG. 17 is a schematic view to explain a so called “beam pitch error” which can be generated in an optical scanning apparatus for scanning multiple light beams simultaneously.

### DETAILED DESCRIPTION

Now, description will be given below of the mode for carrying out the invention according to the invention with reference to the accompanying drawings.

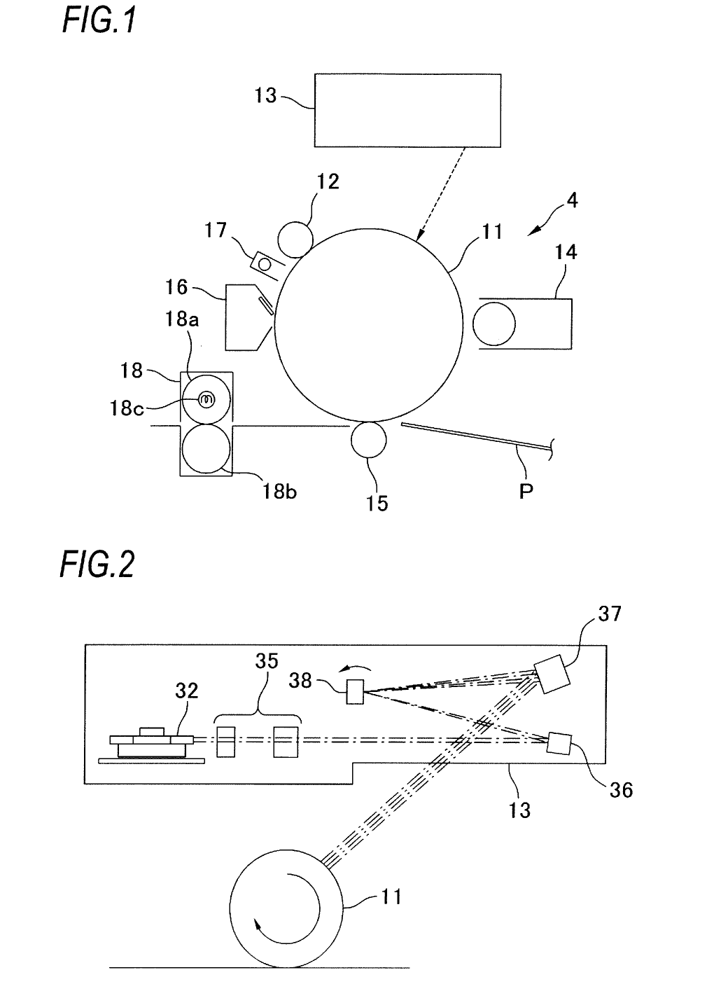

FIG. 1 is a schematic structure view of an image forming apparatus according to a first exemplary embodiment of the invention.

The image forming apparatus includes: a sensitive drum 11 which has a sensitive layer on the cylindrically shaped outer peripheral surface thereof and can be driven and rotated in the peripheral direction thereof; and, a charging device 12 which is disposed opposed to the peripheral surface of the sensitive drum 11 and can charge the peripheral surface almost uniformly. And, in the moving direction of the peripheral surface of the sensitive drum 11 and downstream of the position where the charging device 12 is disposed, there is disposed an optical scanning apparatus 13 which scans the surface of the sensitive drum 11 using the light beams to form latent images. Also, downstream of the position where the light beams are radiated, there are disposed: a developing device 14 which selectively transfers toners onto the latent images on the sensitive drum 11 to form toner images on the sensitive drum 11; a transfer device 15 for transferring the toner images formed on the sensitive drum 11 to a recording sheet P; a cleaning device 16 for removing toners remaining on the sensitive drum 1 after the toner images are transferred; and, an electricity-removing and exposure device 17 for removing electricity from the sensitive drum 11 to initialize the potential thereof.

Also, downstream of the transfer device 15 in the carrying direction of the recording sheet P, there is disposed a fixing device 18 which heats and pressurizes the toner images on the recording sheet P to pressure fix the toner images onto the recording sheet P. And, the recording sheet P, on which the toner images have been fixed by the fixing device 18, is discharged into a tray (not shown).

As the sensitive drum 11, it is possible to use a sensitive drum which includes a cylindrical body made of metal and a sensitive layer made of various kinds of inorganic sensitive materials, organic sensitive materials or the like and formed on the metal-made cylindrical body, while the metal-made cylindrical body is electrically grounded.

The charging device 12 includes a roller made of conductive metal such as stainless steel or aluminum and coated with a coating made of high resistance materials; and, the charging device 12 is contacted with the sensitive drum 11 and can be rotated following the sensitive drum 11. And, when a given voltage is applied to the charging device 12, there is generated electric discharge within a minute clearance between the vicinities of the contact portions of the roller and sensitive drum 11, whereby the charging device 12 can charge the surface of the sensitive drum 4 almost uniformly.

The optical scanning apparatus 13 includes, as a light source, a semiconductor laser device for outputting laser beams which blink according to image signals, and scans the peripheral surface of the sensitive drum 11, which is moving in the peripheral direction, in the width direction using a polygonal rotating mirror serving as deflecting unit. As a result of this, the potentials of the exposure portions dampen on the peripheral surface of the sensitive drum 11, whereby there are formed latent images due to the difference between the electrostatic potentials. The details of the optical scanning apparatus 13 will be described later.

The developing device 14 includes a developer carrier having a thin toner layer on the surface thereof in such a manner that the developer carrier is situated at a position which is near to and opposite to the sensitive drum 11; and, within an electric field generated between the developer carrier and sensitive drum 11, the developing device 14 transfers the toner to the latent image to thereby form a visible image.

The transfer device 15 is disposed opposed to the sensitive drum 11 and forms an electric field between the sensitive drum 11 and itself; and thus, the transfer device 15 electrostatically transfers a toner image on the sensitive drum 11 to a recording sheet P which is to be carried in contact with the sensitive drum 11.

The fixing device 18 includes a heating roller 21 supported to be rotatable around its center axis, a pressurizing roller 22 rotatable while it is pressure contacted parallel with the heating roller 21, and a built-in heating source 23 which is built in the heating roller 21. The recording sheet P, to which the toner image has been transferred by the transfer device 15, is held by and between the heating roller 21 and pressurizing roller 22 and, while it is being pressurized and heated thereby, is carried due to the rotational movements of these rollers. As a result of this, the toner image is pressure attached onto the recording sheet P to thereby form a fixed image.

Next, description will be given in detail of the structure of the optical scanning apparatus 13.

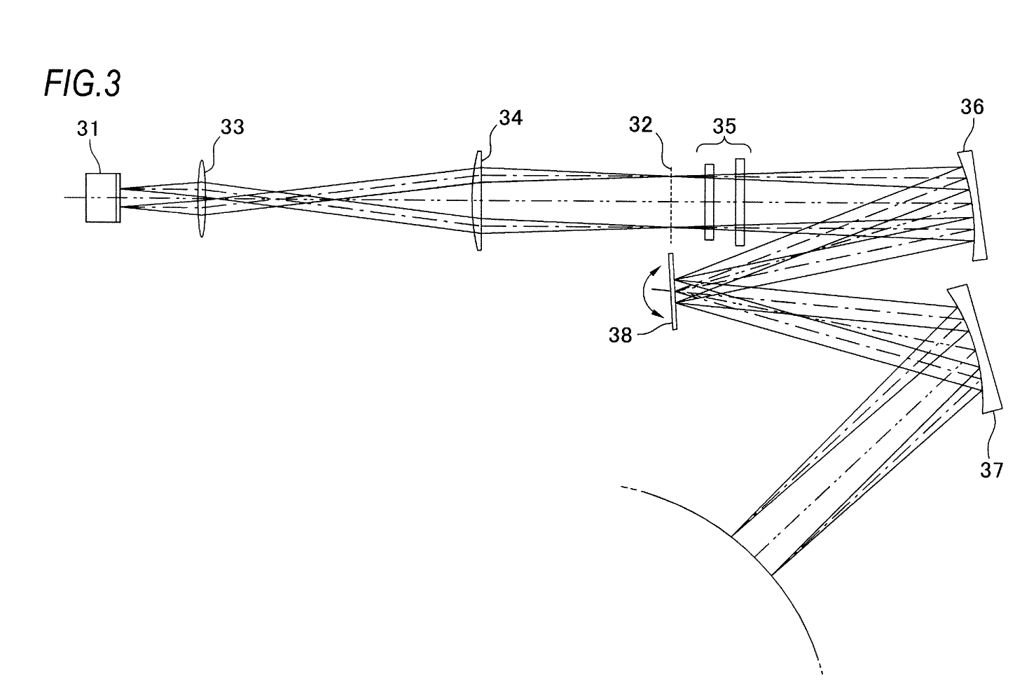

FIG. 2 is a schematic structure view of this optical scanning device 13, and FIG. 3 is a schematic explanatory view of an optical path along which the light beams emitted from a light source arrive at the peripheral surface of the sensitive drum 11 serving as a surface to be scanned.

The optical scanning device 13 includes a laser device 31 (not shown in FIG. 2) serving as a light source for emitting multiple light beams; and, between the laser device 31 and the peripheral surface of the sensitive drum 11 onto which the light beams are radiated, there is interposed a polygonal rotating mirror 32, that is, a so called polygon mirror, serving as deflecting unit. And, the optical scanning device 13 includes a collimater lens 33 and a cylinder lens 34 respectively interposed between the light beam emitting surface of the laser device 31 and polygonal rotating mirror 32. Also, between the reflecting surface of the rotational polygonal mirror 32 and the surface to be scanned on the sensitive drum 11, the optical scanning device 13 includes f θ lenses 35 having such power as condenses the lights only in the main scanning direction as well as first and second cylinder mirrors 36 and 37 respectively disposed downstream of the f θ lenses 35 in the radiating direction of the light beams and having such power as condenses the lights at least in the sub-scanning direction. Further, upstream of the second cylinder mirror 37, there is disposed a light adjust mirror 38 for adjusting the angles of the light beams to be radiated onto the second cylinder mirror 37.

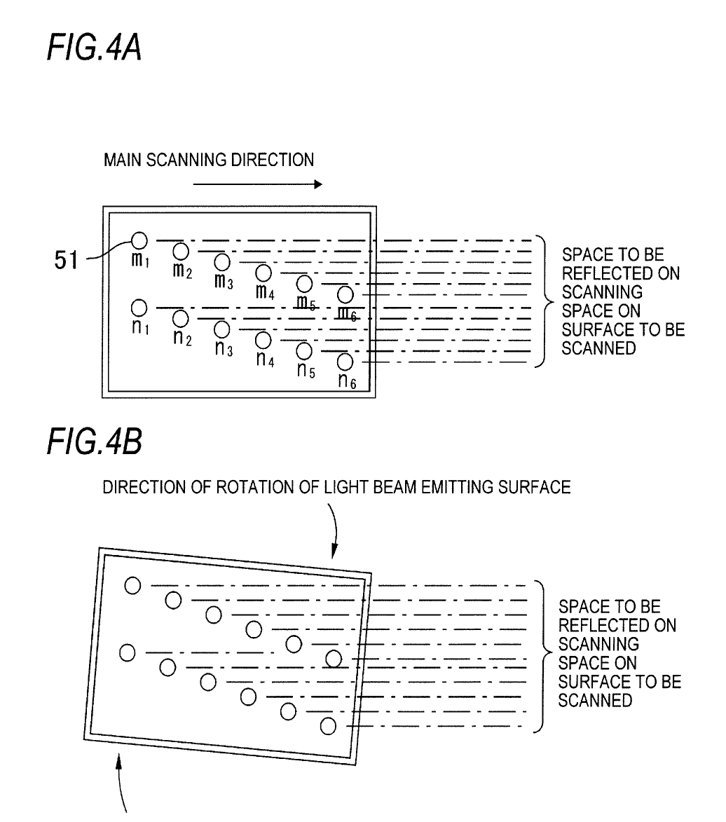

The laser device 31 includes multiple light emitting points which are arranged two dimensionally to serve as surface light emitting lasers; and, the laser device 31 is used to emit multiple light beams. FIG. 4A shows an example of the arrangement of the light emitting points on the emitting surface of the light beams. According to this laser device 31, the light emitting points 51 are arranged in a two-dimensional manner. Specifically, on a straight line having a given angle with respect to directions where the light beams emitted are main-scanned and sub scanned, there are arranged six light emitting points at given intervals and there are formed two such light emitting points arrays. The light beams, which are emitted from these light emitting points, are used to scan scanning lines respectively different in the sub-scanning direction; and, the light beams are modulated in the respective light emitting points and are emitted almost parallel to each other (which means that they are not parallel lights but the advancing directions of the light beams are the same).

Also, the present laser device 31, as shown in FIG. 4B, can be rotated parallel to the emitting surface of the light beams to thereby be able to adjust the positions of the light emitting points. This makes it possible to adjust the space between the directions where the light beams are sub scanned.

The rotational polygonal mirror 32 includes multiple reflecting surfaces on the side surface of a regular polygonal rotating body and can be rotated about the center axis of a regular polygon, that is, can be rotated about an axis perpendicular to a plane containing the regular polygon at a position equidistant from the respective vertexes. The reflecting surfaces of the light beams are arranged parallel to the rotation axis along the respective sides of the regular polygon, and multiple beams emitted from the above laser device are radiated onto the same reflecting surface simultaneously. And, as the rotational polygonal mirror is rotated, the incidence angles of the light beams to be radiated onto the respective reflecting surfaces are caused to vary successively, and thus the reflected lights are deflected. This allows the multiple light beams to scan the peripheral surface of the sensitive drum 11 in the width direction, that is, in the main scanning direction simultaneously.

The collimator lens 33 not only converts the multiple light beams, which have been emitted from the respective light emitting points 51, from diverging lights to substantially parallel lights, but also condenses the respective light beams in the sub scanning direction. In other words, the multiple light beams emitted parallel from the laser device are converted to parallel lights and are allowed to converge such that they intersect each other at the focal position F on the image side (on the advancing direction downstream side of the light beams) of the collimator lens 33.

The cylinder lens 34 has such power as condenses the lights only in the sub scanning direction; and, the multiple light beams are allowed by the cylinder lens 34 to converge in the sub scanning direction respectively, and are then guided to the rotational polygonal mirror 32.

Also, the cylinder lens 34, may be arranged such that the focal position of the cylinder lens 34 on the laser device side (on the advancing direction upstream side of the light beams) can coincide with the focal position F of the collimator lens 33 on the side of the surface to be scanned (on the advancing direction downstream side of the light beams), and also such that the focal position of the cylinder lens 34 on the side of the surface to be scanned can exist on the reflecting surface of the rotational polygonal mirror 32. Owing to this arrangement of the cylinder lens 34, the laser device 31 and the reflecting surface of the rotational polygonal mirror 32 are afocal and conjugate relative to each other in the sub scanning direction. Therefore, the multiple light beams not only are allowed to form images on the reflecting surface of the rotational polygonal mirror 32 but also are radiated onto the reflecting surface of the rotational polygonal mirror 32 parallel to each other in the sub scanning direction without having any angle in the sub scanning direction.

The f θ lenses 35 are used to adjust the scanning speeds of the light beams so as to be equal to each other when the light beams deflected by the rotational polygonal mirror 32 are scanned in the axial direction of the peripheral surface of the cylindrical-shaped sensitive drum 11. Since the light beams are so deflected by the rotational polygonal mirror 32 as to turn, the distance from the reflecting surface of the rotational polygonal mirror 32 to the surface to be scanned varies; however, the scanning speeds of the respective light beams can be adjusted by the f θ lenses 35.

The first and second cylinder mirrors 36 and 37, which are respectively interposed between the f θ lenses 35 and the peripheral surface of the sensitive drum 11, have such power as condenses the lights mainly in the sub scanning direction; and thus, they can guide the respective light beams to the sensitive drum 11 and also allows the light beams to form images on the peripheral surface of the sensitive drum 11.

The first and second cylinder mirrors 36 and 37, may be arranged in such a manner that the focal position of the first cylinder mirror 36 on the sensitive drum 11 side can coincide with the focal position of the second cylinder lens 37 on the laser device 31 side, that is, the optical path length between the first and second cylinder mirrors 36 and 37 provides the sum of the focal distance of the first cylinder mirror 36 and the focal distance of the second cylinder mirror 37. Owing to this arrangement of the first and second cylinder mirrors 36 and 37, the reflecting surface of the rotational polygonal mirror 32 and the scanning position of the peripheral surface of the sensitive drum 11 can be set afocal and conjugate relative to each other in the sub scanning direction.

The adjust mirror 38 is interposed between the first and second cylinder mirrors 36 and 37 and, when it is rotated about the optical axis, the angle of the surface to be scanned can be adjusted in a direction corresponding to the sub scanning direction. Thus, the adjust mirror 38 can be used to adjust the angles of the light beams that are radiated from the first cylinder mirror 36 onto the second cylinder mirror 37.

The adjust mirror 38, as shown in FIG. 3, may be set at the position that provides not only the focal position of the first cylinder mirror 36 on the sensitive drum 11 side but also the focal position of the second cylinder mirror 37 on the laser device 31 side.

Next, description will be given below of the operation of the optical scanning device 13 when it scans the peripheral surface of the sensitive drum 11.

The multiple light beams, which have been emitted parallel from the laser device 31, are converted to substantially parallel lights by the collimator lens 33, are allowed by the cylinder lens 34 to converge in the sub scanning direction, and are radiated onto the reflecting surface of the rotational polygonal mirror 32. And, after the multiple light beams are radiated onto the rotational polygonal mirror 32, they are deflected due to the rotational movement of the rotational polygonal mirror 32.

At the then time, when the laser device 31 and the reflecting surface of the rotational polygonal mirror 32 are afocal and conjugate with respect to each other, the multiple light beams emitted parallel from the respective light emitting points 51 are radiated onto the reflecting surface of the rotational polygonal mirror 32 in such a manner that they are parallel to each other and have not any angle relative to the reflecting surface of the rotational polygonal mirror 32 in the sub scanning direction. That is, the multiple light beams are radiated onto the reflecting surface of the rotational polygonal mirror 32 parallel to the optical axis of the optical system. This can prevent the generation of a Defferential bow that could be otherwise caused due to the deflected light beams by the rotational polygonal mirror 32.

Also, suppose images are formed on the reflecting surface of the rotational polygonal mirror 32, even when there is generated an error in the angle of the reflecting surface, that is, even when the reflecting surface has a slight angle relative to the optical axis of the optical system, the scanning position on the peripheral surface of the sensitive drum 11 will be hardly influenced.

The multiple light beams deflected due to the rotational movement of the rotational polygonal mirror 32 are radiated onto the f θ lens 35, and the scanning speeds by the multiple light beams when main-scanning the peripheral surface of the sensitive drum 11 using the light beams can be made equal to each other. And, the multiple light beams are allowed to form images on the peripheral surface of the sensitive drum 11 by the first and second cylinder mirrors 36 and 37 having such power as condenses the lights mainly in the sub scanning direction. At the then time, the angles of the multiple light beams when they are radiated onto the second cylinder mirror 37 are adjusted by the adjust mirror 38. This not only causes the effective focal distance of the second cylinder mirror 37 to vary but also adjusts the space between the multiple light beams.

Next, description will be given below of the principle of the adjustment of the space between the multiple light beams.

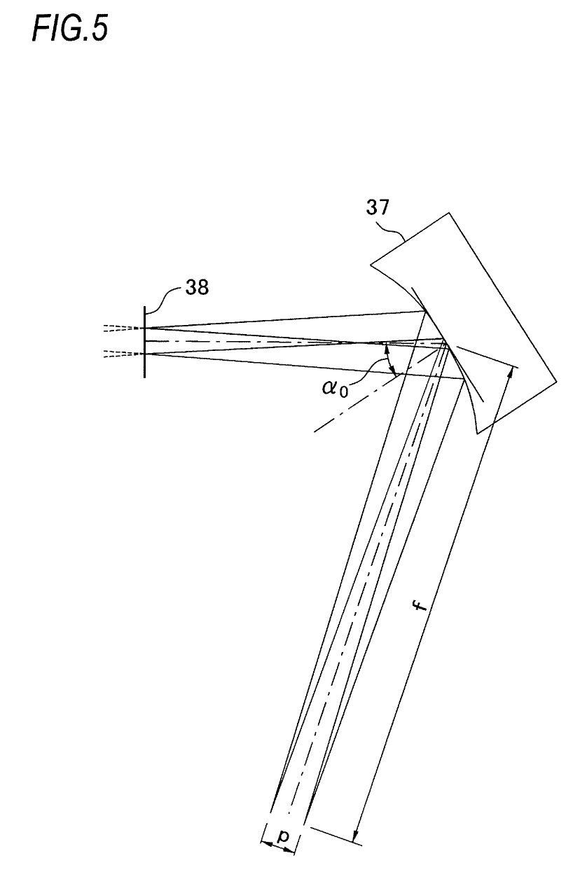

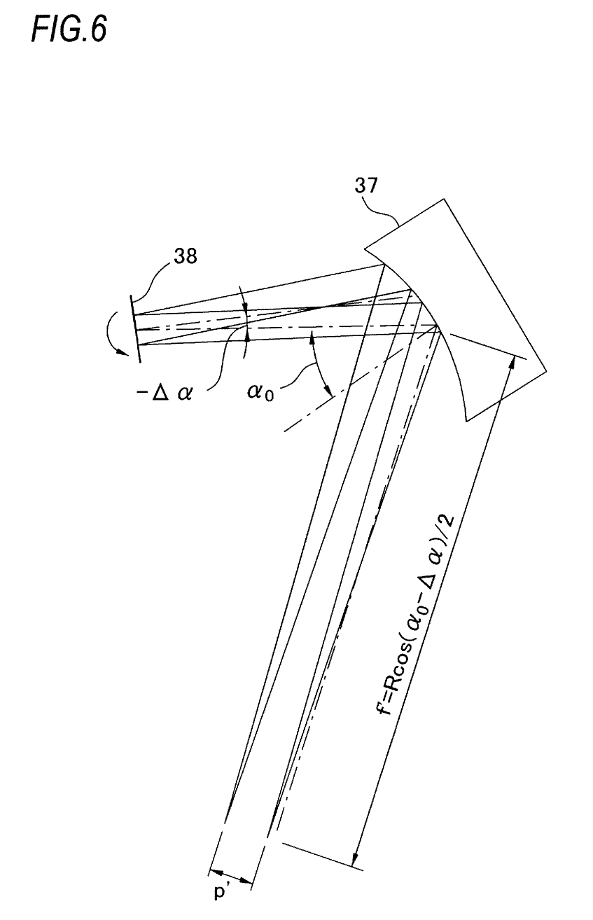

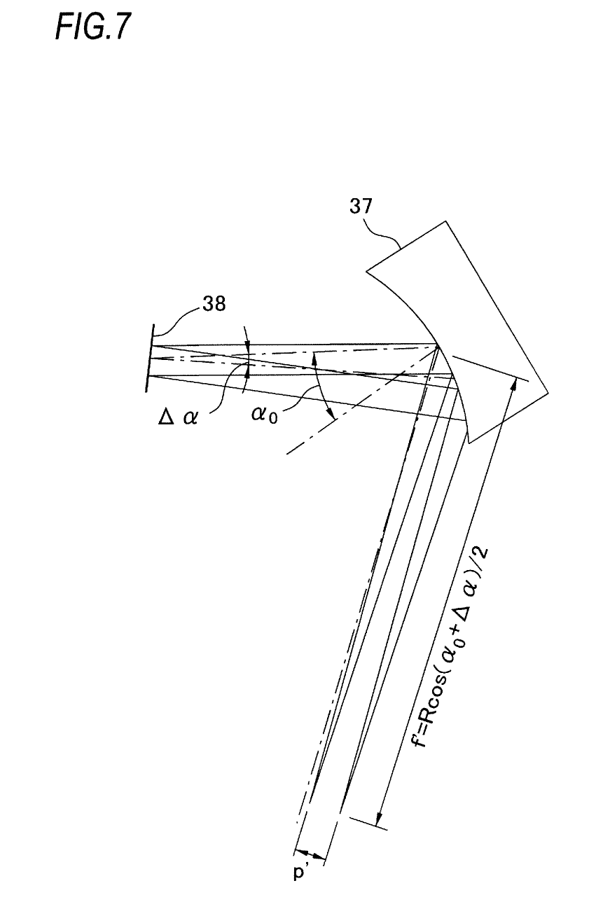

As shown in FIG. 5, when the multiple light beams are radiated onto the second cylinder mirror 37 with the optical axes thereof at an angle of α0, the rotational movement of the adjust mirror 38, as shown in FIG. 6, can reduce the incidence angle, or, as shown in FIG. 7, can increase the incidence angle. In the case of a reflecting optical element, where the radius of curvature is expressed as R, the focal distance f thereof can be expressed in the following manner: that is, f=R×cos (α0)/2. And, according to a variation Δα of the incidence angle, the focal distance f′ can be expressed in the following manner: that is, f′=R×cos(α0+Δα)/2. Therefore, when the incidence angle reduces, that is, when Δα becomes negative, the effective focal distance f′ is larger than f, and the scanning space p between the multiple optical beams in the sub scanning direction also increases. On the other hand, when the incidence angle increases, that is, when Δα becomes positive, the effective focal distance f′ is smaller than f, and the scanning space p between the multiple optical beams in the sub-scanning direction also reduces. In this manner, by adjusting the incidence angles of the light beams to be radiated onto the second cylinder mirror 37, the space between the multiple light beams can be adjusted.

And, when the space between the light beams is adjusted in this manner, the optical system is not moved in the optical axis direction, thereby being able to avoid the following inconveniences. That is, when the position of the cylinder lens is changed between the laser device 31 and the rotational polygonal mirror 32 serving as the deflecting unit to adjust the scanning space between the light beams on the sensitive drum 11, the angles of the light beams radiated onto the reflecting surface of the rotational polygonal mirror 32 are varied, which causes the “Defferential bow”. Also, by moving the positions of the cylinder mirrors 36 and 37 in the optical axis direction between the reflecting surface of the rotational polygonal mirror 32 and the surface to be scanned, the scanning space between the multiple light beams in the sub scanning direction can be adjusted; however, an amount of defocusing increases. According to the invention, since the space between the light beams is adjusted without moving the optical elements in the optical axis direction, the above-mentioned Defferential bow and defocusing can be prevented.

Next, description will be given below of the results of a test which has been conducted in order to confirm the effects of the invention.

In this test, the space in the sub scanning direction where the multiple light beams scan the surface of the sensitive drum 11 was so adjusted as to be changed using the optical scanning apparatus 13 shown in FIG. 3; and, the scanning space between the light beams in the sub-scanning direction, the amount of shift of a focal point for condensing the light in the sub scanning direction, and the amount of variation of the incident angle of the light to be radiated onto the surface to be scanned, that is, the surface of the sensitive drum 11 were respectively measured at different positions in the main scanning direction.

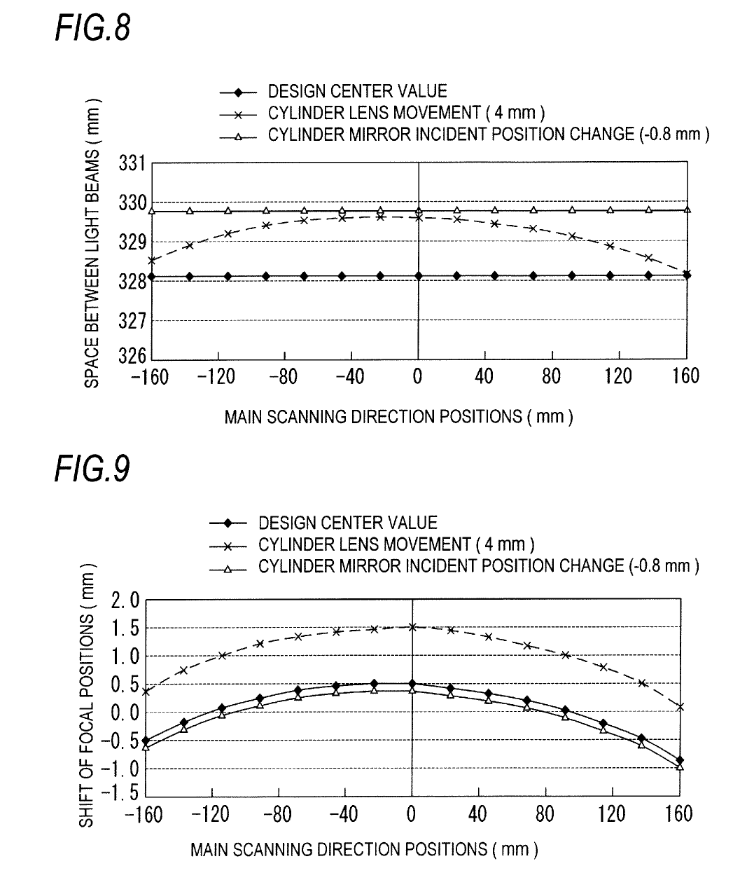

FIG. 8 shows the results of the sub scanning direction scanning spaces measured at the respective points in the main scanning direction in case where the sub scanning direction scanning spaces when two light beams are scanned on the sensitive drum 11 were so adjusted as to be enlarged by 1.6 μm at the width direction (main scanning direction) central position of the peripheral surface of the sensitive drum 11. In this figure, values respectively shown by marks ♦ express a state before the scanning spaces were adjusted. And, values respectively shown by marks x express the results obtained when the position of the cylinder lens 34 interposed between the laser device 31 and polygonal rotating mirror 32 was moved in the optical axis direction to thereby adjust the scanning spaces. Also, values respectively shown by marks Δ express the results obtained when the incident angle of the light onto the second cylinder mirror 37 interposed between the rotational polygonal mirror 32 and sensitive drum 11 was adjusted to thereby change the light incident position of the second cylinder mirror 37.

As shown in FIG. 8, when the incident angles of two light beams to be radiated onto the second cylinder mirror 36 are adjusted, the scanning space between the two light beams is enlarged almost by 1.6 μm at the central position in the main scanning direction and is enlarged almost by the same amount also in the end portion in the main scanning direction. On the other hand, when the cylinder lens is adjusted in the optical axis direction, the scanning space is enlarged almost by 1.6 μm at the central position in the main scanning direction but, as it goes nearer to the two end portions in the main scanning direction, the amount of enlargement of the scanning space reduces. That is, there is generated the “Defferential bow”.

FIG. 9 shows the results obtained in a test in which, when the space between the two light beams to be scanned on the sensitive drum 11 is adjusted so that it was enlarged by 1.6 μm at the central position of the peripheral surface of the sensitive drum 11 in the width direction (in the main scanning direction), the amounts of shift in the optical axis direction of the position of a focus for condensing the light in the sub scanning direction were measured at multiple positions in the main scanning direction.

As shown in FIG. 9, when the incident angles of the two light beams to be radiated onto the second cylinder mirror 37 was adjusted (which is shown by marks: Δ, Δ - - - ), the position of the focus is hardly changed from the state thereof (which is shown by design central values: ♦, ♦, - - - ) before the incident angle is adjusted but, when the cylinder lens 34 is adjusted in the optical axis direction (which is shown by marks: x, x, - - - ), the focal position is shifted about 1 mm in the optical axis direction. Due to such shift amount of the focal position, the light beams are out of focus, which results in the degraded writing quality of a clear image.

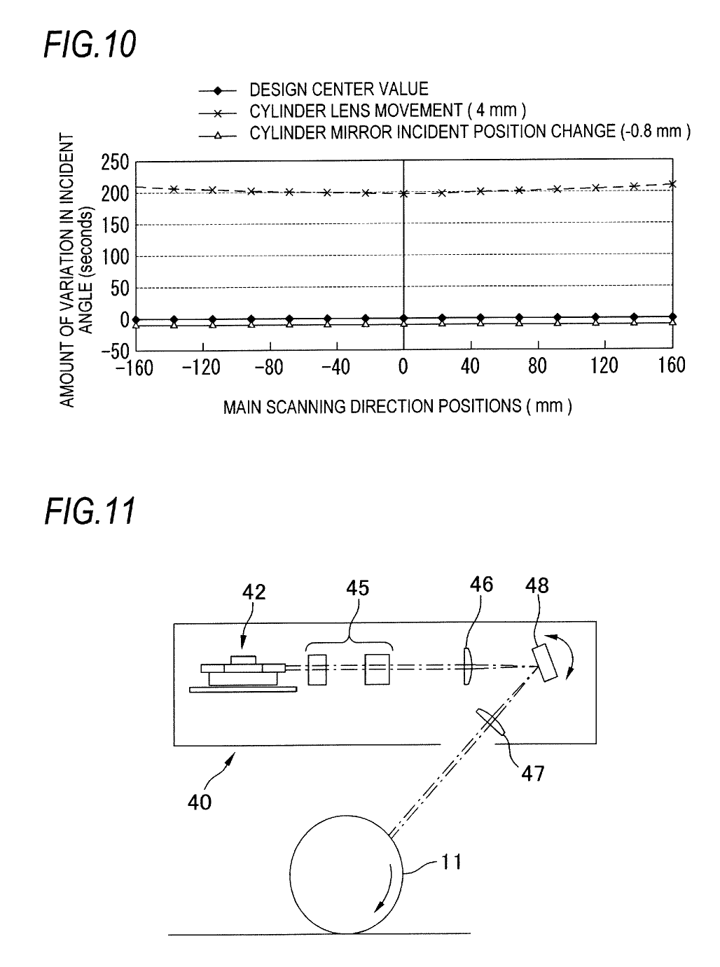

FIG. 10 shows the results obtained in a test in which, when the space between the two light beams to be scanned on the sensitive drum 11 was adjusted so that it was enlarged by 1.6 μm at the central position of the peripheral surface of the sensitive drum 11 in the width direction (in the main scanning direction), the amount of variation of the incident angles of the lights to be radiated onto the sensitive drum 11 were measured at multiple positions in the main scanning direction.

As shown in FIG. 10, when the incident angles of the light beams to be radiated onto the second cylinder mirror 37 are adjusted (which is shown by marks: Δ, Δ, - - - ), the incident angles of the light beams to be radiated onto the peripheral surface of the sensitive drum 11 change hardly from the state thereof before the incident angles are adjusted (which is shown by design central position values: ♦, ♦, - - - ); but, when the cylinder lens is adjusted in the optical axis direction (which is shown by marks: x, x, - - - ), the incident angle changes about 200 seconds. Such angle change causes the pitch to shift when the distance to the surface to be scanned varies.

Next, description will be given below of an optical scanning apparatus according to a second exemplary embodiment of the invention with reference to FIGS. 11 to 13B.

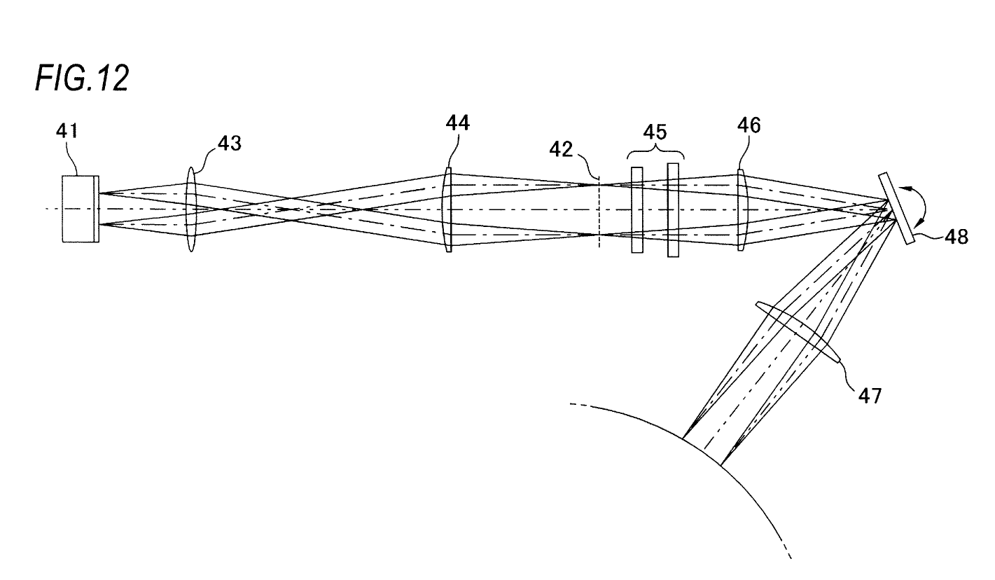

This optical scanning apparatus 40, as shown in FIG. 12, includes a laser device 41, a polygonal rotating mirror 42, a collimator lens 43, and a cylinder lens 44 disposed nearer to the laser device 41 than the rotational polygonal mirror 42, which are similar to those employed in the optical scanning apparatus shown in FIG. 3. However, between the rotational polygonal mirror 42 and the surface to be scanned, instead of the first and second cylinder mirrors 36 and 37, there are interposed first and second cylinder lenses 46 and 47. Also, an adjust mirror 48 is the same as the mirror that is used in the optical scanning apparatus shown in FIG. 3; and, the adjust mirror 48 is used to adjust the angles of the light beams to be radiated onto the second cylinder lens 47 in a direction corresponding to the sub scanning direction.

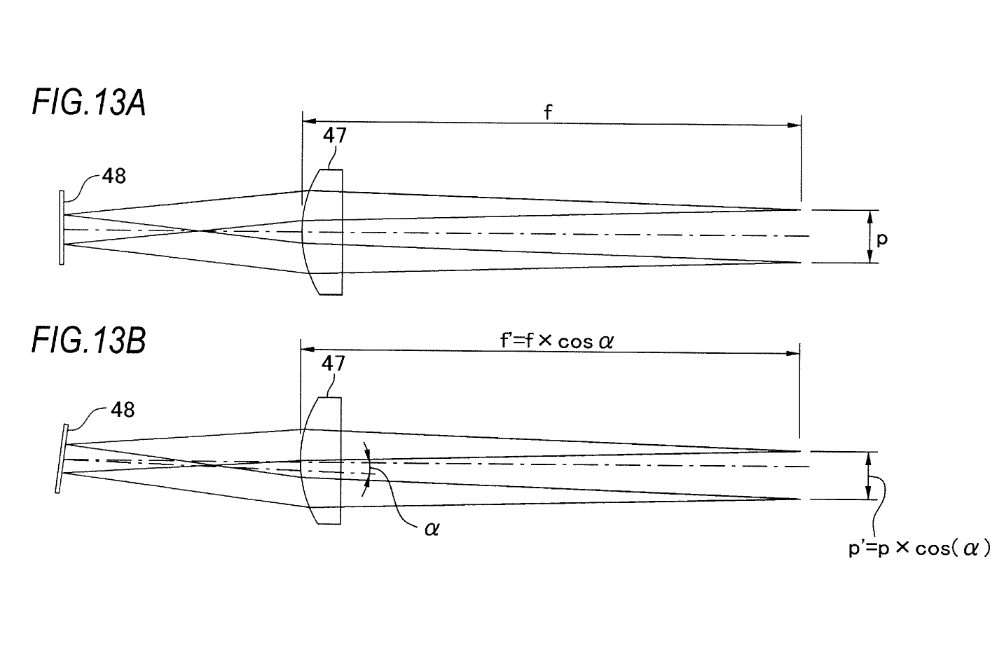

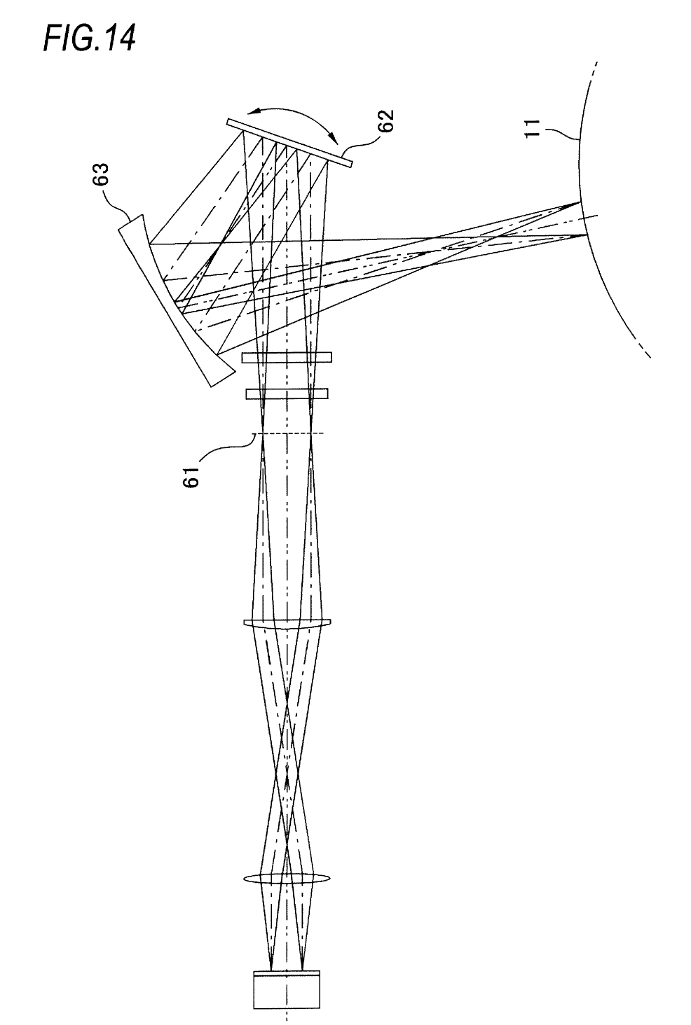

According to the optical scanning apparatus 40, multiple light beams emitted from the laser device 41 are radiated through the collimator lens 43 and cylinder lens 44 onto the rotational polygonal mirror 42, the multiple light beams are deflected by the same rotating and moving reflecting surface of the rotational polygonal mirror 42 and, after then, the multiple light beams are allowed to form images on the peripheral surface of the sensitive drum 11 serving as the surface to be scanned by f θ lenses 45, first cylinder lens 46 and second cylinder lens 47. And, by adjusting the angle of the adjust mirror 48 in a direction corresponding to the sub scanning direction, the angles of the light beams to be radiated onto the second cylinder lens 47 can be changed. In the case of the multiple light beams with their incident angles onto the second cylinder lens 47 changed in this manner, the space, at which the multiple light beams scan on the surface to be scanned, is changed. In other words, when the incident angle of 0° onto the second cylinder lens 47 as shown in FIG. 13A is changed into an angle of α as shown in FIG. 13B, the scanning space between the multiple light beams in the sub scanning direction is reduced.

Such adjustment of the scanning space can be made by changing an effective focal distance, which will be discussed below.

Specifically, where “f” is used to express a focal distance when the light beam is radiated onto the cylinder lens at an incident angle of 0°, an effective focal distance f′ when the incident angle is α can be obtained in the following manner: that is, f′=f×cos α. And, in this case, the scanning space p between the multiple light beams can be expressed as p′, and p′ can be obtained in the following manner: that is, p′=p×cos α. Thus, the above-mentioned scanning space can be adjusted in this manner.

However, when a cylinder lens is used instead of a cylinder mirror, the scanning space p becomes the greatest when the incident angle is 0°; and, whether the incident angle α is positive or negative, the scanning space p is reduced. Therefore, the adjusting range of the scanning space p is reduced.

The invention is not limited to the above-described exemplary embodiments but, for example, the following changes are also possible.

An optical system, which is interposed between a laser device and a polygonal rotating mirror, may be structured such that it can radiate the multiple light beams parallel onto the reflecting surface of the rotational polygonal mirror. However, an optical scanning apparatus according to the invention may include a structure in which the multiple light beams are radiated not parallel to each other onto the reflecting surface of the rotational polygonal mirror; that is, even in the thus-structured optical scanning apparatus, the scanning space between the light beams can be adjusted by an adjust mirror. The optical scanning apparatus, in which the multiple light beams are radiated parallel onto the reflecting surface, can reduce the generation of the Defferential bow” when compared with the apparatus in which the light beams are radiated not parallel to each other. Also, an optical scanning apparatus may be structured such that images can be formed at the positions of the reflecting surface of the rotational polygonal mirror, but the invention is not always limited to such structure capable of forming images on the reflecting surface. For example, even when the images are formed on the reflecting surface to thereby provide an error in the angle of the reflecting surface, that is, even when the angle of the reflecting surface is not perpendicular to the optical axis ranging from the laser device to the surface to be scanned but is inclined due to a manufacturing error or the like, the images reflected by the reflecting surface are formed on the surface to be scanned, whereby the light beams can be scanned at given positions.

On the other hand, an optical system, which is interposed between a polygonal rotating mirror and a surface to be scanned, may be structured such that, when multiple light beams reflected by the rotational polygonal mirror are emitted with their optical axes parallel to each other, the optical system allows these light beams to be radiated onto the surface to be scanned parallel to each other. For example, the focal position of the first cylinder mirror or first cylinder lens on the side of the surface to be scanned may be coincident with the focal position of the second cylinder mirror or second cylinder lens on the side of the rotational polygonal mirror. However, the invention is not limited to such optical system that meets the above condition, but there may also be employed another structure in which multiple light beams to be radiated onto the surface to be scanned are not parallel to each other. Further, when the focal positions are coincident with each other in the above-mentioned manner, the adjust mirror may be disposed at the position of the above-set focus; however, it may also be disposed at a position different from the focus.

Also, when two mirrors or lenses are coincident in the focal position with each other, the two mirrors or lenses can also be set at positions moved to the side of the rotational polygonal mirror or to the side of the surface to be scanned while maintaining the space between the two mirrors or lenses.

On the other hand, although the above-mentioned optical system interposed between the rotational polygonal mirror and the surface to be scanned includes the two mirrors or lenses for condensing the lights in the sub scanning direction, there may also be provided two or more mirrors or lenses, or only one mirror or lens. When only one mirror or lens is used, as shown in FIG. 14, the incident angles of multiple light beams deflected by a polygonal rotating mirror 61 onto a cylinder mirror 62 or a cylinder lens are to be adjusted by an adjust mirror 63, thereby being able to adjust the scanning space between the multiple light beams the images of which are formed on the surface to be scanned.

Next, description will be given below of a method for adjusting the scanning space between multiple light beams in the sub scanning direction, for use in the optical scanning apparatus using the laser device 31 having light emitting points arranged in such arrays as shown in FIGS. 4A and 4B and the adjust mirror 38 according to the invention.

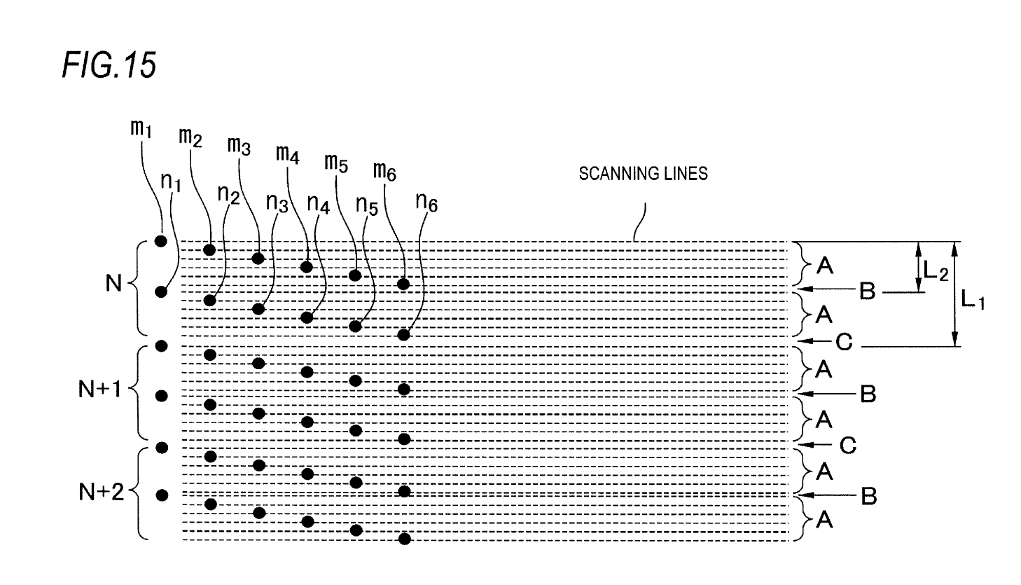

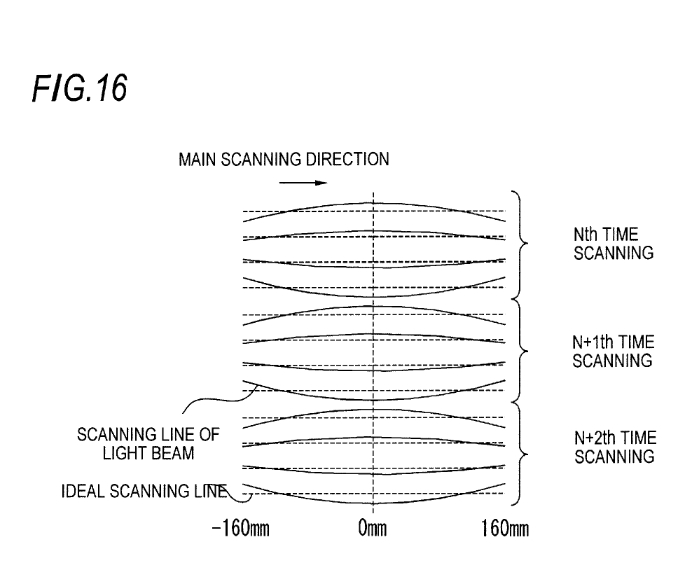

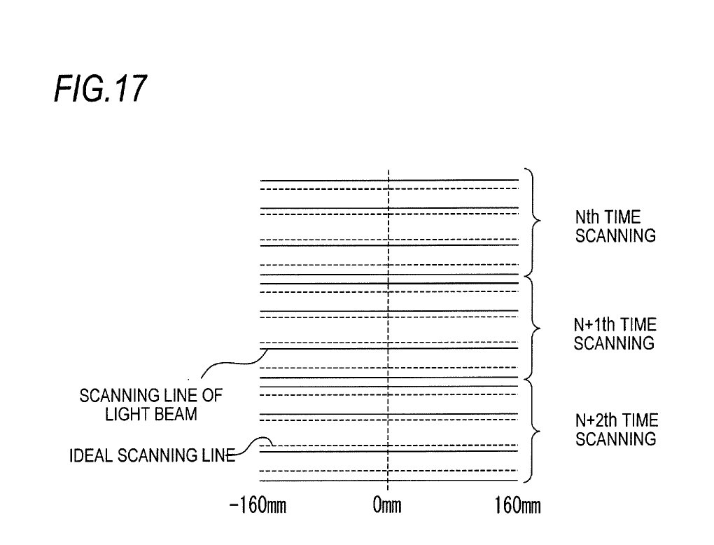

The light beam emitting surface of the laser device 31 can be rotated around its axis parallel to the optical axes of the light beams to be emitted. Thus, when the emitting surface is rotated around the axis, the space, at which the light beams scan the surface to be scanned, can be adjusted. This adjustment is made in such a manner that all the light beams emitted from the light emitting points, m1 to n6, can be scanned at equal intervals in the sub scanning direction. In other words, when this emitting surface is rotated clockwise as shown in FIG. 4B, the scanning space between the light beams emitted from the light emitting points within the light emitting point rays, m1 to m6 as well as n1 to n6, increases, while the scanning space of the light beams emitted from the light emitting points m6 and n1 reduces. Therefore, the scanning positions of the light beams are measured while changing the rotation angle of the emitting surface, whereby a scanning space A for the light beams within the light emitting point arrays shown in FIG. 15 is made equal to the scanning space B for the light beams emitted from the light emitting points m6 and n1 respectively belonging to different light emitting point arrays. In other words, the emitting surface of the laser device 31 is set at an angle where the scanning spaces between all light beams emitted from the light emitting points, m1 to n6, can be made equal to each other. For example the space between m1 and m2 and the space between m6 and n1 are measured and the two measured spaces are adjusted to be equal to each other, whereby the scanning line spaces in the sub scanning direction of multiple light beams arranged in a two-dimensional manner can be made equal to each other. Here, the measurement of the scanning positions can be made using an optical sensor or the like which is provided on the surface to be scanned.

When multiple light beams scan multiple scanning lines simultaneously at one scanning operation, it is assumed that the spaces between the scanning lines are set equal in the above-mentioned manner. A first scanning operation is carried out in the main scanning direction and, after then, a second scanning operation is carried out. And, the space between the scanning lines scanned in the first and second scanning lines is measured. In other words, there is measured a space L1 between a scanning line scanned by a light beam emitted from the light emitting point m1 in the Nth time scanning operation and a scanning line scanned by a light beam emitted from the light emitting point m1 in the next scanning operation, that is, in the N+1 time scanning operation. Also, the scanning space between light beams to be scanned in one scanning operation is measured. For example, the scanning space L2 between light beams respectively emitted from the light emitting points m1 and n1 is measured. And, these measured values are compared with each other. When it is found that L1 is twice as large as L2 (the number of rays of light emitting points), a space C, at which the light beam emitted from the light emitting point n6 in the Nth time scanning operation and the light beam emitted from the light emitting point m1 in the N+1th time scanning operation scan, is also equal to spaces A and B between multiple scanning lines to be scanned in one scanning operation. Therefore, the scanning lines when they are scanned repeatedly in the main scanning direction are all equal in space.

When L1 is not twice as large as L2 in the above-mentioned manner, the angle of the adjust mirror 38 is adjusted to thereby adjust the space between multiple scanning lines to be scanned in one scanning operation; and, such adjustment and measurement are to be repeated until L1 becomes twice as large as L2.

A method for adjusting the space between the multiple scanning lines is not limited to the above-mentioned method. For example, the scanning line space between m1 and n6 may be measured, the measured scanning line space may be converted according to the distance where the surface to be scanned is moved in the sub scanning direction for a period of time necessary to carry out one scanning operation, whereby the scanning speed or the moving speed of the surface to be scanned may be adjusted or measured in such a manner that the scanning line space between m1 and n6 can be equal to the space between the light beams to be scanned simultaneously.

In the above-mentioned adjustment, when the value of L2 cannot be adjusted to meet the above conditions simply by adjusting the angle of the adjust mirror 38, the adjustment can also be made in combination with an operation to replace the cylinder lens 34 interposed between the laser device 31 and polygonal rotating mirror 32 with another cylinder lens having a different radius of curvature. An optical scanning apparatus, in which, as described above, the adjustment using the adjust mirror 38 is possible and also the cylinder lens 34 can be replaced with another cylinder lens having a different radius of curvature. As the structure capable of replacing the cylinder lens 34, for example, there can be employed a structure in which lens support members are respectively fixed previously to multiple lenses different in the radius of curvature, and these lens support members can be mounted onto lens support base portions provided at the previously determined positions of the main body of the optical scanning apparatus. In the thus structured apparatus, after the spaces between the multiple scanning lines to be scanned in one scanning operation are adjusted to be equal in the above-mentioned manner, the cylinder lens 34 is selected and is adjusted such that the relationship between L2 and L1 can have a value near to the above-mentioned condition; and, after then, the angle of the adjust mirror 38 is adjusted to thereby allow the relationship between L2 and L1 to satisfy the above condition.

In an optical scanning apparatus or image forming apparatus according to the invention, the main scanning direction and sub scanning direction are generally set perpendicular to each other. However, the invention can also be applied to a case in which the main scanning direction and sub scanning direction are set at an angle which is slightly different from the right angles.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An optical scanning apparatus, comprising:
a light source that emits multiple light beams;
a deflecting unit that accepts the multiple light beams emitted from the light source on an identical reflecting surface of the deflecting unit, and movies the reflecting surface to deflect the multiple light beams; and,
an optical system that is interposed between the reflecting surface of the deflecting unit and a surface to be scanned and converges the multiple light beams reflected by the reflecting surface respectively,
wherein the surface to be scanned is scanned using the deflected multiple light beams in a main scanning direction, and
the multiple light beams are used to scan positions different from each other in a sub scanning direction crossing with the main scanning direction, and
wherein the optical system includes a optical element that converges lights at least in the sub scanning direction,
the optical scanning apparatus further includes an adjust unit that adjusts incident angles of the multiple light beams radiated onto the optical element, in a direction corresponding to the sub scanning direction on the surface to be scanned.

2. The optical scanning apparatus according to claim 1, wherein
the optical system includes:
a first optical element; and
a second optical element that is disposed on the side of the surface to be scanned of the optical system, and
wherein both the first optical element and the second optical element converses lights at least in a sub scanning direction,
the adjust unit is interposed between the first and second optical elements, and
the adjust unit adjusts the incident angles of the multiple light beams to be radiated onto the second optical element.

3. The optical scanning apparatus according to claim 2, wherein
the optical system radiates the multiple light beams reflected by the deflecting unit with axes of the multiple light beams parallel to each other onto the surface to be scanned in such a manner that the axes of the multiple light beams are parallel to each other.

4. The optical scanning apparatus according to claim 3, wherein
the adjust unit is an adjust mirror that adjust an angle of the adjust mirror in a direction corresponding to the sub scanning direction on the surface to be scanned, and
the adjust unit is disposed in the vicinity of a focal position of the first optical element on the side of the surface to be scanned.

5. The optical scanning apparatus according to claim 1,
wherein the optical element is a reflecting optical element having a radius of curvature in a direction corresponding at least to the sub scanning direction on the surface to be scanned.

6. An optical scanning apparatus, comprising:
a light source that emitting multiple light beams;
a coupling optical system that arranges the multiple light beams emitted from the light source substantially as parallel lights;
a shaping optical system that converges the multiple light beams arranged substantially parallel by the coupling optical system at least in the sub scanning direction, wherein the shaping optical system includes a first optical element;
a deflecting unit that accepts the multiple light beams emitted from the light source on an identical reflecting surface of the deflecting unit, and movies the reflecting surface to deflect the multiple light beams;
an image forming optical system that is interposed between the identical reflecting surface of the deflecting unit and the surface to be scanned and that allows the multiple light beams deflected by the reflecting surface to form images on the surface to be scanned, wherein the image forming optical system includes an second optical element that converges lights at least in a sub scanning direction; and,
an adjust unit that adjusts incident angles of the multiple light beams to be radiated onto the second optical element in a direction corresponding to the sub scanning direction on the surface to be scanned,
wherein the surface to be scanned is scanned using the deflected light beams in a main scanning direction,
the multiple light beams are used to scan positions different from each other in a sub scanning direction crossing with the main scanning direction,
the first optical element is replaceable to change spaces between the multiple light beams in a sub scanning direction on the surface to be scanned, and
the spaces between the multiple light beams in the sub scanning direction on the surface to be scanned are adjusted by the adjust unit and by the replacement of the second optical element.

7. The optical scanning apparatus according to claim 6, wherein the spaces between the multiple light beams on the surface to be scanned is changed step by step by replacement of the optical element included in the shaping optical system,
the adjust unit is capable of changing the space between multiple light beams successively, and
the spaces between the multiple light beams changed stepwise by the replacement of the first optical element are interpolated by the successive space changes made by the adjust unit.

8. An optical scanning apparatus, comprising:
a light source unit that includes multiple light emitting points arranged two-dimensionally on a surface perpendicular to the emitting direction of an beam, the light source unit emitting light beams respectively from the light emitting points;
a deflecting unit that accepts the multiple light beams emitted from the light source unit on an identical reflecting surface of the deflecting unit and moving the reflecting surface to deflect the multiple light beams; and
an optical system that is interposed between the deflecting unit and a surface to be scanned and that respectively converges the multiple light beams reflected by the reflecting surface,
wherein a surface to be scanned is scanned using the deflected light beams in a main scanning direction on and the multiple light beams are used to scan positions different from each other in a sub scanning direction crossing with the main scanning direction,
the light source unit is rotatable in an in-plane direction perpendicular to the light emitting direction and adjusts rotation angles,
the optical system includes an optical element that converges lights at least in a sub scanning direction, and
the optical scanning apparatus further includes an adjust unit that adjusts the incident angles of the multiple light beams to be radiated onto optical elements in a direction corresponding to the sub scanning direction on the surface to be scanned.

9. An image forming apparatus, comprising:
an image carrier that includes an endless shaped peripheral surface movable in the peripheral direction thereof and a sensitive layer formed on the peripheral surface;
a charging device that charges the peripheral surface of the image carrier;
an optical scanning apparatus that radiates an image light onto the image carrier to form an electrostatic latent image thereon;
a developing device that transfers a toner to the electrostatic latent image formed on the image carrier to develop a toner image;
a transfer unit that transferring the toner image to a transfer member directly or through an intermediate transfer member; and,
a fixing unit that fixes the toner image,
wherein the optical scanning apparatus comprises:
a light source that emits multiple light beams;
a deflecting unit that accepts the multiple light beams emitted from the light source on an identical reflecting surface of the deflecting unit, moves the reflecting surface to deflect the multiple light beams, and scans the endless shaped peripheral surface of the image carrier in the width direction thereof by using the multiple light beams simultaneously in a main scanning direction; and
an optical system that is interposed between the identical reflecting surface of the deflecting unit and the peripheral surface of the image carrier and converges the multiple light beams reflected by the identical reflecting surface,
wherein a surface to be scanned is scanned using the multiple light beams repetitively in the width direction at positions different from each otherin a sub scanning direction on,
the peripheral surface of the image carrier is moved in the peripheral direction to form continuous latent images on the image carrier in the peripheral direction thereof,
the optical system includes an optical element that converges lights at least in a sub scanning direction, and
the optical system includes incidence an adjust unit that adjusts the incident angles of the multiple light beams to be radiated onto optical elements in a direction corresponding to the sub scanning direction on the surface to be scanned.
